(19) United States
(12) Patent Application Publication
(10) Pub. No.: US 2003/0090787 A1
(43) Pub. Date: May 15, 2003

(54) Optical assembly for viewing at night or under other vision impaired conditions

(76) Inventor: Samuel A. Dottle, Sonora, CA (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/291,462

(22) Filed: Nov. 8, 2002

Related U.S. Application Data
(60) Provisional application No. 60/345,332, filed on Nov. 9, 2001.

(51) Int. Cl. G02B 1/00; G02B 5/08; G02B 5/20; F21V 9/04; F21V 9/06; G02B 21/36; G02B 23/00

(52) U.S. Cl. 359/358; 359/350; 359/361; 359/363

(57) ABSTRACT

An optical assembly is provided that allows a user to view objects with normal perspective and scale under conditions of total darkness, in daylight, or other conditions limiting normal vision, or adverse weather conditions. The optical assembly includes a white light flashlight, with a filter cap mounted to the illuminating end of the flashlight. The filter cap permits infrared light in the appropriate range of 900 to 1200 nanometers to pass through. The optical assembly further includes a camera pack including a camera, and preferably including a transmitter. Said camera pack attached to the flashlight and in communication with a display mounted to a head gear worn by the user so that the screen of the display is directly in front of an eye of the user. The camera lens of the camera pack and the illuminating end of the flashlight are aligned along a single linear optical axis. The camera pack communicates with the display via a communication means when wireless communication is not preferred. The optical assembly includes a receiver coupled to the display when wireless communication is preferred, said receiver permits wireless transmission of images from the transmitter disposed within the camera pack. The receiver will also provide wireless communication between the receiver and a remote source equipped with a transmitter.

In use, the object under surveillance is targeted by the illuminating light of the flashlight. A portion of the light is filtered by the filter cap, and a portion is passed through the filter cap to the object, the camera receives the light reflected off the object and generates a video signal to the display responsive to the received light, for which may be viewed by the human eye.

### CROSS REFERENCES TO RELATED APPLICATIONS

U.S. Provisional Application Patent No. 60/345,332, filed Nov. 9, 2001, with title “Night Vision Apparatus” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention is directed toward a vision enhancement system, and more particularly towards an optical assembly which allows a user to view objects with normal perspective and scale under conditions of total darkness, or other conditions limiting normal vision, or adverse weather conditions.

2. Brief Description of Prior Art

Clear vision with correct depth and size or scale perspective under adverse conditions is critically important in many situations. For example, nighttime military operations require a complete and accurate knowledge of the surroundings. Prior art systems such as radar, and laser based systems and the like have provided means for locating and ranging surrounding objects such as buildings, military equipment and even personnel under conditions of darkness and smoke. They are based upon the specific characteristics of the identified objects. As an example, radar identification systems depend upon, among other parameters, the object's electromagnetic reflectivity characteristics. Such physical characteristics might not be sufficient to fully identify the object.

Electro-opical devices are available that use an image tube that collect small articles of moonlight and starlight. These devices produce shades of green images having poor resolution. Thermal imaging devices known in the art operate in totally dark environment relying only on thermal energy from the objects being viewed. These devices produce a ghost-type image having further resolution. In addition, the prior art systems described above are typically large, are often mounted in a command post or vehicle, and are not designed to be comfortably carried and worn by personnel.

Head mounted display systems have been developed for a number of different applications including use by military personnel. Prior art head displays are generally limited by their resolution and by their size and weight. Existing displays have relatively low resolution, and because of the size and weight of available systems, these displays are often positioned at the relatively large distance from the eye. Of particular importance, is the desirability of keeping the center of gravity of the display from extending upward and forward from the center of gravity of the head and neck of the wearer, where it will place a large torque on the wearer's neck and may further interfere with other instruments during use.

There is a continuing need to present images to the wearer of a helmet mounted display in high-resolution format similar to that of a computer monitor. The display needs to be as non-intrusive as possible, leading to the need for lightweight and compact design.

As will be seen from the subsequent description, the preferred embodiments of the present invention overcome shortcomings of the prior art.

### SUMMARY OF THE INVENTION

The present invention provides an optical assembly and method related thereto for detecting objects at night, during daylight or at relatively low visible light levels, including adverse weather conditions. The optical assembly generally includes a head gear having a front side and a back side, a white light flashlight such as a halogen, a filter cap mounted to the illuminating end of the flashlight, a camera pack attached to the upper surface of the flashlight, a display preferably mounted to the front side of the head gear, a first connection having one end electrically connected to the display and the opposite end connected to a junction box attached to the head gear, said junction box connected to a receiver for wireless communication between the camera pack and the display and, when wireless communication is not preferred, an optional second connection having one end electrically connected to said junction box and the opposite end connected to the camera pack.

The filter cap is operatively disposed over the illuminating end of the flashlight. Application of the filter cap blocks visible light, thereby permitting infrared light in the appropriate range of 900 to 1200 nanometers to pass through.

The camera pack includes a camera housing, said housing having a front aperture, a camera board affixed within the housing with a clamp and screws. Said camera pack is powered by batteries. Further disposed within the housing includes a power conversion board, a modular jack, a slide switch and switch cover, an encoder board, and internal connectors known in the art. An o-ring is disposed within the front aperture, and a lens shield is further disposed in the aperture in communication with the o-ring. Said o-ring and lens shield is attached to the front aperture of the housing with screws. Said camera pack may further include an optional multi-channel transmitter for wireless communication with the receiver. Said modular jack of the camera pack for attachment with the second connection to interface with the display when wireless communication is not preferred. The camera pack further includes a means of attachment for mounting the camera pack onto the surface of the flashlight.

The display includes a rear housing connected to one end of a front display housing, a display board is disposed therein, and a rubber eyecup attached to the opposite end of the front display housing, and internal connectors known in the art. Said rear housing including a recessed portion and a back surface opposite the recessed portion. Said recessed portion of the housing is appropriately connected to the front display housing .

The display further includes a flexible goose neck having a first end and a second end, the second end attached to the outer surface of a quick mount ring through a clamp and thumb screw. Said quick mount ring positioned on the recessed portion of the rear housing. The first end of the goose neck attached to a mount display with a screw.

The first connection is appropriately connected to the display board within the display. Specifically, an inner cord relief having a center aperture and a plurality of screw apertures is aligned with an outer cord relief having a center aperture and a plurality of screw apertures. Said inner and outer cord reliefs each having a circular shape and configuration so that the screw apertures of the inner cord relief are in alignment with the screw apertures of the outer cord relief. The center apertures of the inner and outer cord reliefs are in nonalignment. One end of the first connection is guided through the center aperture of the outer cord relief, and then is guided through the center aperture of the inner cord relief. Said end of the first connection is then attached to a 4-pin connector of the display board. The opposite end of the first connection having a modular plug for connection to the junction box.

The inner cord relief is attached to the outer cord relief with screws. Since the center apertures of the inner and outer cord reliefs are in non-alignment, that portion of the first connection disposed between the said center apertures is caused to pinch or slightly bend thereby effectively preventing the connection from releasing from the reliefs. The attached reliefs are positioned within the rear housing so that the outer surface of the outer cord relief defines the back surface of the rear housing. The perimeter of the inner and outer cord reliefs are in rotating communication with the interior surface of the rear housing such that rotational motion of the reliefs results in rotational movement of that portion of the connection disposed between the outer cord relief and the inner cord relief; however, the display board within the display remains stationary.

When wireless communication is preferred, power for the display is provided preferably by the receiver; and, when wireless communication is not preferred, power for the display is provided preferably by the camera pack.

The receiver includes a housing having a multi-channel receiver board, a power board, a DC power jack connector, a jack connector, a slide switch, a push button switch, and internal connectors known in the art. Said receiver is powered by batteries. The housing of the receiver further includes a modular jack for appropriate connection of the receiver to the junction box attached to the head gear. The receiver permits wireless transmission of images between the wearer of the optical assembly and the transmitter disposed within the camera pack. The receiver will also provide wireless communication between the receiver and a remote source equipped with a transmitter. In addition, the receiver may include a global positioning satellite sensor or other position sensor for accurately determining the position of the wearer of the optical assembly.

### BRIEF DESCRIPTION OF THE DRAWINGS

FIG. 1 is a perspective view of a preferred embodiment of the present invention, an optical assembly for viewing at night or under other vision impaired conditions.

FIG. 2 is a perspective view of a camera pack of the optical assembly of FIG. 1.

FIG. 3 is a perspective view of a miniature display of the optical assembly of FIG. 1.

FIG. 4 is a perspective view of the optical assembly of FIG. 1 attached to head gear.

FIG. 5 is an exploded perspective view of the camera pack of FIG. 2.

FIG. 6 is an exploded perspective view of the display of FIG. 3.

FIG. 7 is an exploded perspective view of the rear housing of the display of FIG. 3.

FIG. 8 is a sectional view of the back surface of the rear housing of FIG. 7.

FIG. 9 is an exploded perspective view of the display board of the display of FIG. 3.

FIG. 10 is an exploded perspective view of a receiver of the optical assembly of FIG. 1.

FIG. 11 is a side perspective view of the display of FIG. 3.

### DESCRIPTION OF THE PREFERRED EMBODIMENTS

In accordance with the present invention, an optical assembly and method related thereto for detecting objects at night, in daylight, or at relatively low visible light levels, including adverse weather conditions is disclosed. More particularly, the present invention concerns an optical assembly which allows a user to view objects with normal perspective and scale under conditions of total darkness, or other conditions limiting normal vision, or adverse weather conditions.

Specifically, it will be noted in the following description that the disclosed optical assembly relates to an improved head mounted display system having a relatively high display resolution, and is lightweight. In the broadest context, the present optical assembly consists of components configured and correlated with respect to each other so as to attain the desired objective.

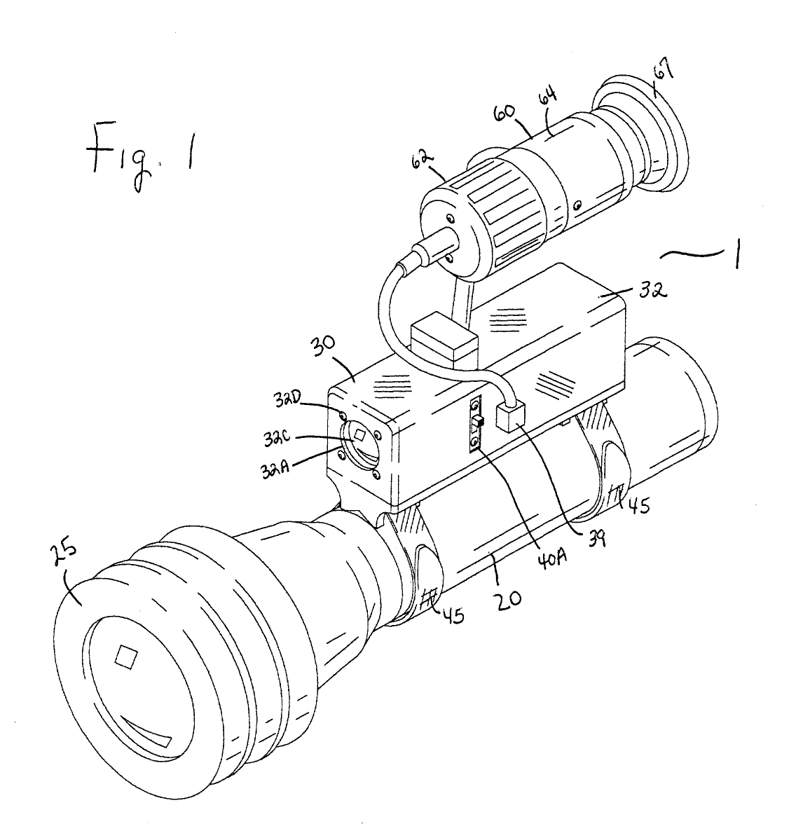

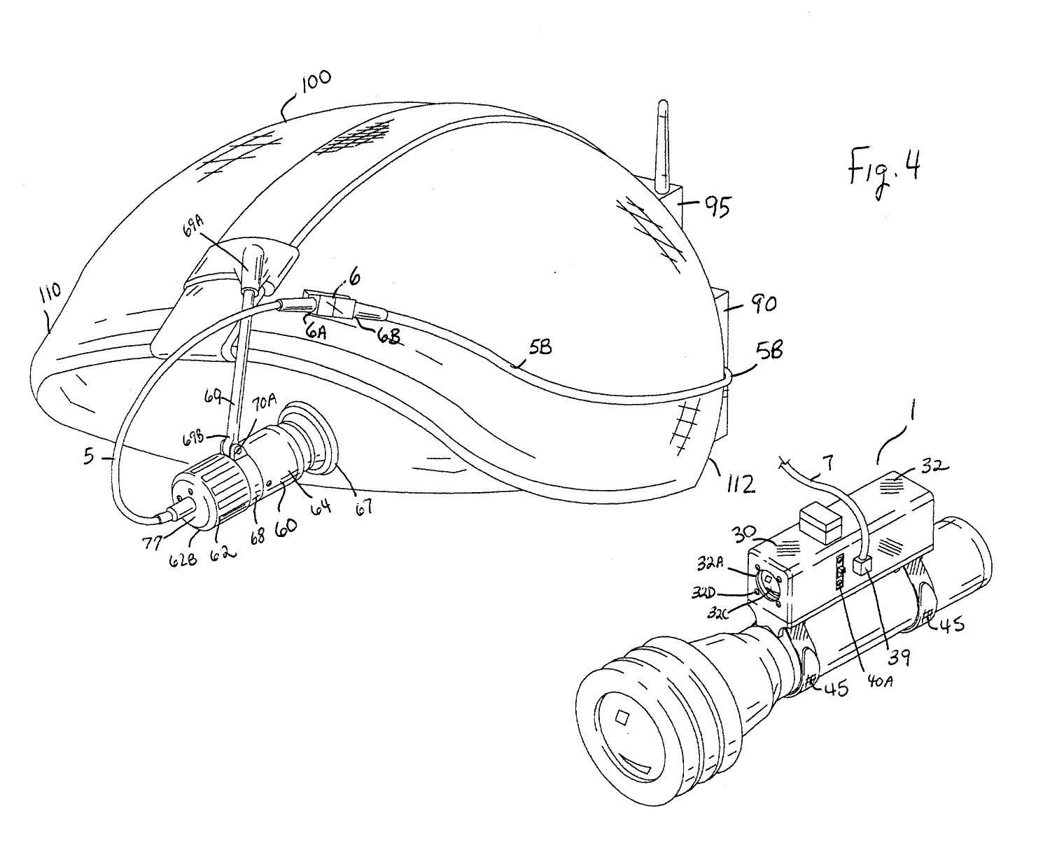

FIGS. 1-11 illustrate a preferred embodiment of an optical assembly 1 made in accordance with the present invention. As shown in FIG. 1, the optical assembly 1 generally includes a head gear 100 (shown in FIG. 4) having a front side 110 and a back side 112, a white light flashlight 20 such as a halogen, a filter cap 25 mounted to the illuminating end of the flashlight 20, a camera pack 30 attached to the upper surface of the axial length of the flashlight 20, a display 60 preferably mounted to the front side 110 of the head gear 100 (as shown in FIG. 4), a connection 5 having one end electrically connected to the display 60 and the opposite end connected to a first connector end 6A of a junction box 6 (shown in FIG. 4). The junction box 6 having a second connector end 6B opposite the first connector end 6A. Referring to FIG. 4, when wireless communication is preferred, one end of a connection 5B is connected to the second connector end 6B and the opposite end of connection 5B is connected to a receiver 95 as will be further discussed. When wireless communication is not preferred, a connection 7 having one end connected to the camera pack 30 as will be further described and the opposite end connected to the second connector end 6B of the junction box 6.

The filter cap 25 is operatively disposed over the illuminating end of the flashlight 20.

Application of the filter cap 25 blocks visible light, thereby permitting infrared light in the appropriate range of 900 to 1200 nanometers to pass through, which is key to enhancing night vision. Many objects in the environment that are dark in the visible light spectrum are brightly illuminated in the infrared light spectrum. Accordingly, it is advantageous to use the filter cap 25 as described to generate the image of the object during the cover of darkness. In the preferred embodiment, the filter cap 25 is mounted on to the illuminating end of the flashlight 20.

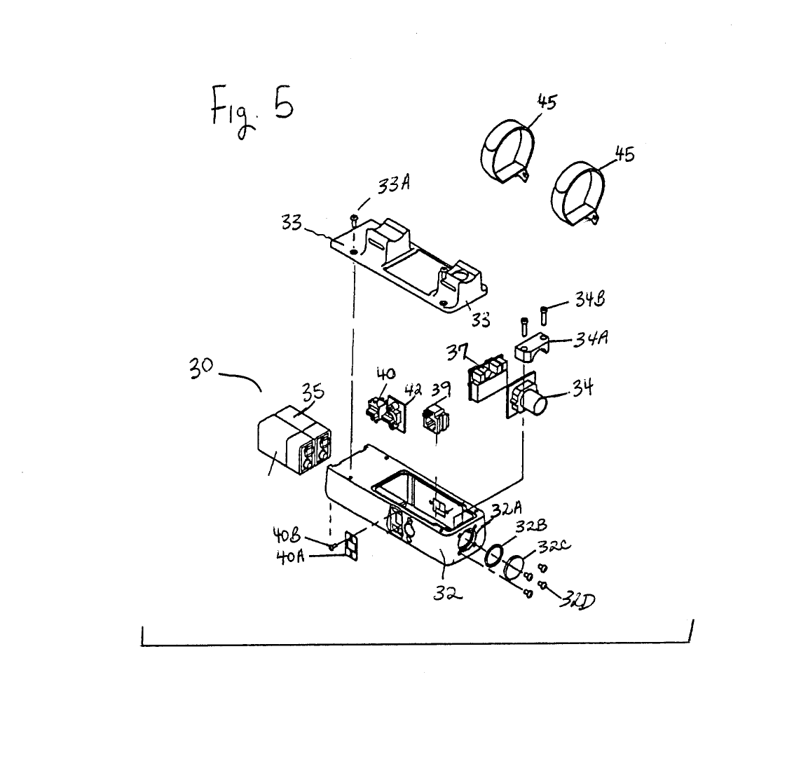

The camera pack 30 is provided to generate a video signal responsive to reflected infrared light received by the camera pack 30. The camera pack 30 includes a camera housing 32, said housing 32 having a top surface 33 to enclose and protect the various components of the camera pack 30. The top surface 33 is attached to the housing 32 with screws 33A. As best shown in FIGS. 2, 4 and 5, the housing 32 having a front aperture 32A, a camera board 34 disposed in parallel communication with the front aperture 32A, said camera board 34 affixed within the housing with a clamp 34A and screws 34B (shown in FIG. 5). Said camera pack 30 is powered by batteries 35, said batteries preferably disposed within the housing 32 opposite the front aperture 32A. Further disposed within the housing 32 includes a power conversion board 37, a modular jack 39, a slide switch 40 and switch cover 40A attached to the outer surface of the housing 32 with screws 40B, an encoder board 42, and internal connectors (not shown) known in the art. Said power conversion board 37 to convert the voltage from the camera pack's 30 batteries to the required voltages. An o-ring 32B is disposed within the front aperture 32A, and a lens shield 32C is further disposed in the aperture 32A in communication with the o-ring 32B. Said o-ring 32B and lens shield 32C appropriately attached to the front aperture 32A of the housing 32 with screws 32D. Said camera pack 30 may further include an optional multi-channel transmitter 44 for wireless communication with the receiver 95 as will be further discussed. Said modular jack 39 of the camera pack 30 for attachment with the connection 7 to interface with the display 60 when wireless communication is not preferred.

The camera pack 30 further includes a means of attachment 45 for mounting the camera pack 30 onto the surface of the flashlight 20. In the preferred embodiment, said means of attachment 45 may consist of straps, flexible bands, or other attaching means known in the art.

In use, the front aperture 32A of the camera pack 30 having the camera 34 therein is “aimed” at the object under surveillance thereby detecting images in the general direction in which the camera 34 is directed. The camera pack 30 presents continuous images as recorded by the camera 34 and transmitted to the display 60.

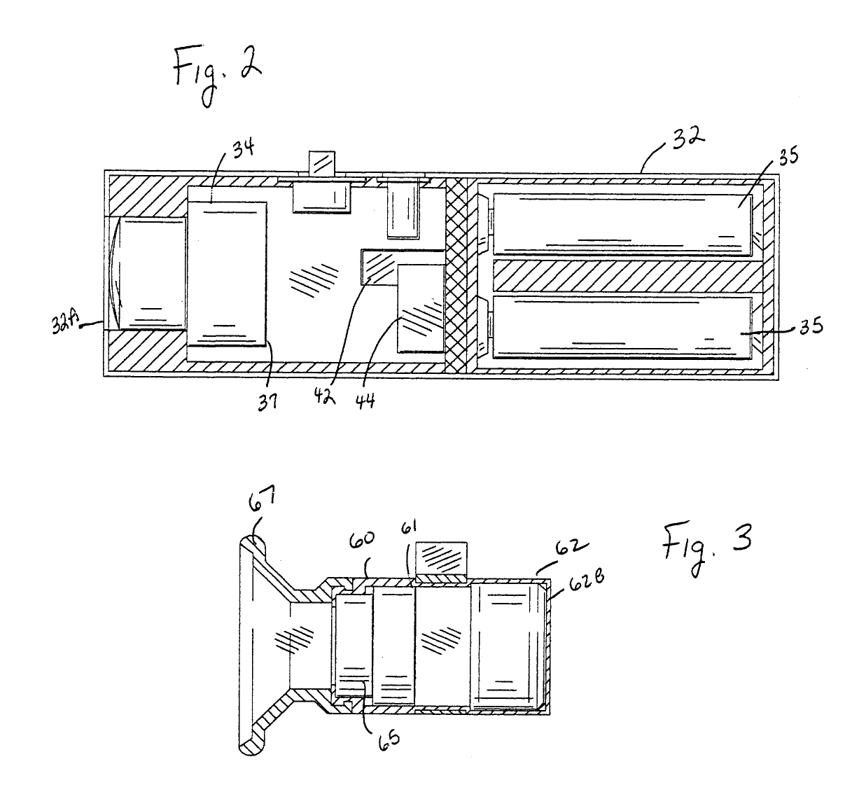

As shown in FIGS. 3, 6 and 11, the display 60 includes a rear housing 62 connected to one end of a front display housing 64, a display board 65 is disposed within the display 60, and a rubber eyecup 67 attached to the opposite end of the front display housing 64, and internal connectors (not shown) known in the art. Said rear housing 62 including a recessed portion 62A and a back surface 62B opposite the recessed portion 62A. Said recessed portion 62A of the housing is appropriately connected to the front display housing 64 as described above.

As best shown in FIGS. 6 and 11, the display 60 further includes a flexible goose neck 69 having a first end 69A and a second end 69B, the second end 69B attached to the outer surface of a quick mount ring 68 through a clamp 70A and thumb screw 70B. Said quick mount ring 68 positioned on the recessed portion 62A of the rear housing 62. The first end 69A of the goose neck 69 attached to a display mount 72 with a screw 72A. The display mount 72 including a spring loaded plunger 74 for coupling to a clip (not shown) disposed at the front side 110 of the head gear 100. Said display mount 72 and clip is known in the art

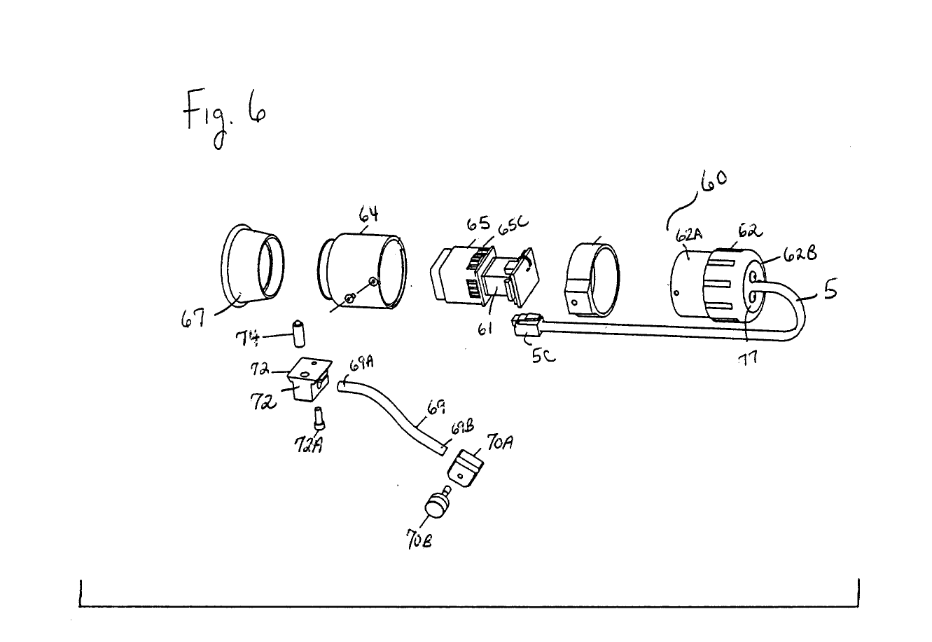

The connection 5 is appropriately connected to the display board 65 within display 60. Referring to FIG. 7, an inner cord relief 75 having a center aperture 75A and a plurality of screw apertures 75B is aligned with an outer cord relief 77 having a center aperture 77A and a plurality of screw apertures 77B. Said inner and outer cord reliefs 75, 77 each having a circular shape and configuration so that the screw apertures 75B are in alignment with the screw apertures 77B. As will be described, the center apertures 75A, 77A are in non-alignment.

A first end 5A of the connection 5 is extended through the center aperture 77A of the outer cord relief 77, and is then guided through the center aperture 75A of the inner cord relief 75. Said end of the connection 5 is then attached to a 4-pin connector 79 of the display board 65. The opposite end of the connection 5 having a modular plug 5C for connection to the first connector end 6A of the junction box 6.

The inner cord relief 75 is attached to the outer cord relief 77 with screws 78. Since the center apertures 75A, 77A are in non-alignment, that portion of connection 5 disposed between the center apertures 75A, 77A (not shown) is caused to pinch or slightly bend thereby effectively preventing the connection 5 from releasing from the reliefs 75, 77. The attached reliefs 75, 77 are positioned within the rear housing 62 so that the outer surface of the outer cord relief 77 defines the back surface 62B of the rear housing 62.

As shown in FIG. 8, the perimeter of the inner and outer cord reliefs 75, 77 are in rotating communication with the interior surface of the rear housing 62 such that rotational motion of the reliefs 75, 77 results in rotational movement of that portion of the connection 5 disposed between the outer cord relief 77 and the inner cord relief 75; however, the display board 65 within the display 60 remains stationary.

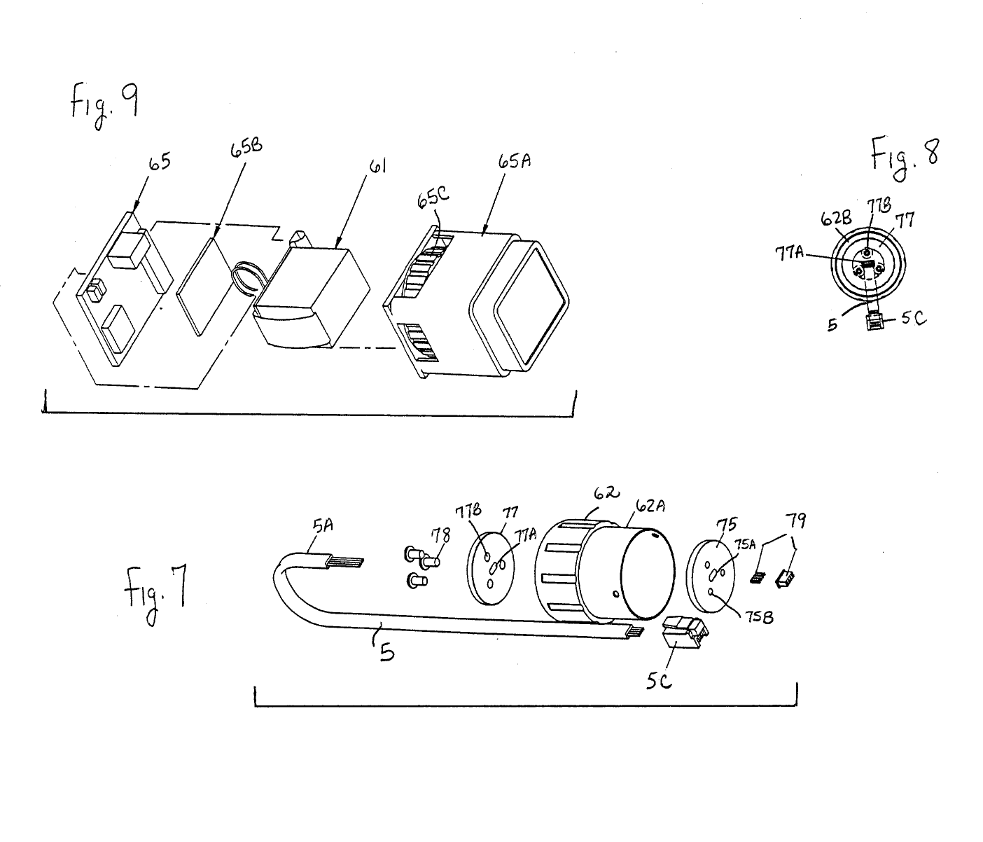

As best shown in FIG. 9, the display board 65 includes a focusing display 65A coupled to a back light with Liquid Crystal Display (LCD) 61. In the preferred embodiment, a double sided tape 65B is disposed between the black light with LCD 61 and the display board 65. The display board 65 is known in the art. Focus is accomplished with a sliding gauge system 65C incorporated into the focusing display 65A.

The rear housing 62 design and the flexible goose neck 69 attached to the rear housing 62 by the quick mount ring 68 as described accommodate selected viewing orientations of the image displayed on the LCD 61 by the viewer. Manually rotating the inner and outer cord reliefs 75, 77 disposed within the rear housing 62 effectively rotates the display 60. Selectively configuring the goose neck 69 likewise positions the display 60 independent of the rear housing 62 design as discussed above.

In use, the mount display 72 attached to the first end 69A of the goose neck 69 is connected to the front side 110 of the head gear 100 so that the display 60 extends downward from the head gear 100 and the LCD 61 is directly in front of an eye of the user (shown in FIG. 4). Regardless of the image's orientation as displayed by the LCD 61, the display 60 may be appropriately positioned by rotating the reliefs 75, 77 within the rear housing 62, or adjusting the goose neck 69 attached to the quick mount ring 68 as discussed above, so that the users view through the LCD 61 is of correct orientation.

When wireless communication is preferred, power for the display 60 is provided preferably by the receiver 95; and, when wireless communication is not preferred, power for the display 60 is provided preferably by the camera pack 30.

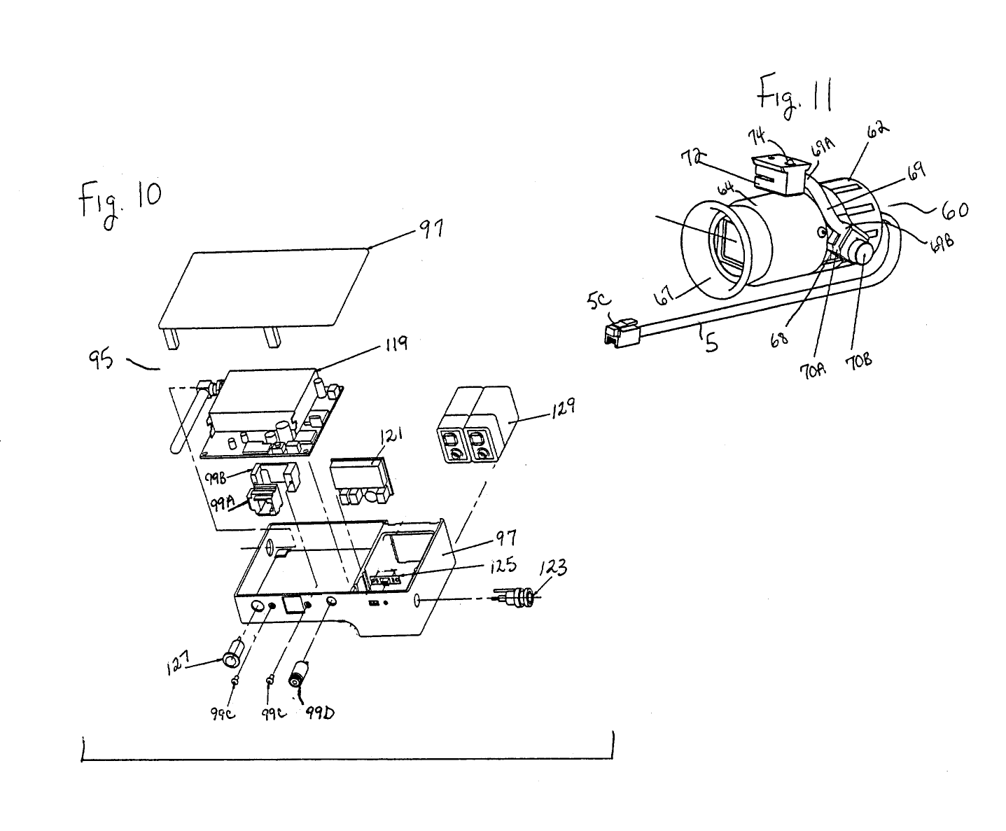

As shown in FIG. 10, the receiver 95 includes a housing 97 to enclose and protect the various components of the receiver 95. The receiver 95 further having a modular jack 99A for appropriately connecting the receiver 95 to the second connector end 6A of the junction box 6. Said modular jack 99A attached to the housing 97 with a clamp 99B and screws 99C. The receiver 95 further includes a multi-channel receiver board 119, and a power conversion board 121 disposed within the housing 97, and internal connectors (not shown) known in the art. Further disposed in the housing 97 includes a DC power jack connector 123, a jack connector 99D, a slide switch 125, and a push button switch 127. The jack connector 99D to interface a remote channel select switch (not shown) preferably attached near a hand of the operator. Said receiver 95 is powered by batteries 129. Said power conversion board 121 to convert the voltage from the batteries 129 to the required voltages. In the preferred embodiment, the receiver 95 is attached to the back side 110 of the head gear 100.

It should be understood that the optical assembly 1 can be self-contained such that no physical connection to camera pack 30 is required. In particular, the receiver 95 provides wireless data communication between the wearer of the optical assembly 1 and the transmitter 44 disposed within the camera pack 30. The receiver 95 will also provide wireless communication between the receiver 95 and a remote source equipped with a transmitter. Through the receiver 95, a user located at the remote source can communicate with the wearer of the optical assembly 1.

In addition, the receiver 95 may include a global positioning satellite (GPS) sensor or other position sensor for accurately determining the position of the wearer of the optical assembly 1. The information is combined with the data communication submitted to the remote source as discussed, to provide the wearer of the optical assembly 1 and the user located at the remote source with the wearer's exact location, as well as the wearer's surroundings.

The wiring of the optical assembly 1 and the appropriate connections between the components thereof are known by those skilled in the art.

The optical assembly 1 may be adapted for use in many situations. In particular, there are situations where a head mounted display system is especially advantageous. Such situations typically involve applications where the user desires to view objects with normal perspective and scale under conditions of total darkness, or other conditions limiting normal vision, or adverse weather conditions. Unlike the prior art discussed, the optical assembly 1 of the present invention may be used in daylight (passive mode) and in darkness (active mode). In passive mode, illumination by the flashlight 20 is not necessary however, application of the optical assembly 1 as described above remains unchanged.

Application of the optical assembly 1, like the camera 34 in the camera pack 30, the flashlight 20 is “aimed” at the object under surveillance thereby illuminating such object using the filter cap 25. The flashlight 20 illuminates light through said filter cap 25 which filters out the frequencies that are visible to a human eye. In particular, the filter cap 25 only allows light within the infrared light spectrum to be received by the camera pack 30. The camera pack 30, receives images illustrated by those light frequencies not filtered by said filter cap 25. The images are transmitted to said display 60 for which may be viewed by the human eye.

The images may be transmitted from the camera pack 30 to the display 60 via the connection 7 when wireless communication is not preferred, or from the transmitter 44 of the camera pack 30 to the receiver 95 when wireless communication is preferred. Specifically, when wireless communication is not preferred, the images are transmitted via the connection 7 from the modular jack 39 of the camera pack 30 to the second connector end 6B of the junction box 6, and from the first connector end 6A of the junction box 6 to the display 60 via the connection 5. In the event wireless communication is preferred, the images are transmitted from the transmitter 44 in the camera pack 30 to the receiver 95, and from the modular jack 99A in the receiver 95 to the second connector end 6B of the junction box 6 via the connection 5B, and from the first connector end 6A of the junction box 6 to the display 60 via the connector 5.

The image of the object is reflected back from the flashlight 20 having the filter cap 25 mounted thereon to the camera pack 30 in prospective format in distance and depth. Once captured by the camera pack 30, the image is transmitted to the display 60 as discussed above for which may be viewed by the human eye of the wearer of the assembly 1, and may be further transmitted to the remote central station through the receiver 95 as previously discussed.

The optical assembly 1 and the method of use related thereto in accordance with the present invention, represents a significant improvement over conventional night vision systems and methods. In particular, the optical assembly 1 displays high-resolution format, and is relatively small in size and lightweight. Further, the optical assembly 1 is less expensive, has a larger field-of-view, ands provides higher quality images than known night vision systems.

The fabricated parts not commercially available, such as structural parts, are of common materials such as plastic or metal.

Although the description above contains many specificities, these should not be construed as limiting the scope of the invention but as merely providing illustrations of some of the presently preferred embodiments of this invention.

Thus the scope of the invention should be determined by the appended claims in the formal application and their legal equivalents rather than by the examples given.

I claim:

1. An optical assembly for viewing at night, in daylight, or under other vision impaired conditions, said optical assembly comprising:
a camera pack having image generating circuitry mounted therein and including a camera having a lens, said camera pack attached to a white light flashlight, the flashlight having an illuminating end,
a filter lens mounted to the illuminating end of the flashlight, said filter lens receiving light from the flashlight and reflecting light off an object in a first direction,
a display a having display board and display circuitry mounted therein, said display in continuous communication with said camera pack,
said camera pack for receiving said light reflected off the object and generating a video signal responsive to said received light,
said display to couple said video signal transmitted from the camera pack to an eye of a user,
wherein the lens of the camera pack and the illuminating end of the flashlight are aligned along a single linear optical axis,
connection means for connecting the camera pack to the display,
a power means for powering the camera pack.

2. The optical assembly as recited in claim 1, further comprising a receiver having a multi-channel receiver board.

3. The optical assembly as recited in claim 2, wherein the camera pack further including a multi-channel transmitter, wherein the transmitter is in wireless communication with the receiver.

4. The optical assembly as recited in claim 3, further comprising a head gear having a front side and a back side, wherein the display is pivotally attached to the front side, and the receiver is attached to the back side.

5. The optical assembly as recited in claim 1, wherein the power means is a battery.

6. The optical assembly as recited in claim 1, wherein the filter cap permits infrared light in the range of 900 to 1200 nanometers to pass through.

7. The optical assembly as recited in claim 1, wherein the display further comprising a rear housing having a recessed portion and a back surface, a quick mount ring positioned on the recessed portion of the rear housing, a flexible goose neck having a first end and a second end, wherein the second end is attached to the quick mount ring with a clamp and thumb screw, and the first end of the goose neck attached to a display mount, an inner cord relief having a center aperture and a plurality of screw apertures for attachment to an outer cord relief having a center aperture and a plurality of screw apertures, wherein the screw apertures of the inner and outer cord reliefs are in alignment, wherein the center apertures of the inner and outer cord reliefs are in nonalignment, said center apertures of the inner and outer cord reliefs for receipt of said connection means, wherein an outer surface of the outer cord relief defines the back surface of the rear housing of the display.

8. An optical assembly for viewing at night, or daylight or under other vision impaired conditions, said optical assembly comprising:
a camera pack having image generating circuitry mounted therein and including a camera having a lens, and a multi-channel transmitter, said camera pack attached to a white light flashlight, said flashlight having an illuminating end,
a display having display circuitry mounted therein, said display in continuous communication with said camera pack,
a head gear worn by a user, said head gear having a front side and a back side,
wherein the display is pivotally attached to the front side of the head gear,
a filter lens mounted to the flashlight, said filter lens receiving light from the flashlight and reflecting light in a first direction,
said camera pack for receiving said light reflected off an object and generating a video signal responsive to said received light,
said display to couple said video signal transmitted from the camera pack to an eye of a user,
wherein the lens of the camera pack and the illuminating end of the flashlight are aligned along a single linear optical axis,
a receiver having a multi-channel receiver board, said receiver attached to the back side of the head gear,
wherein the transmitter of the camera pack is in wireless communication with the receiver,
connection means for interfacing the receiver to the display, and
a power means for powering the camera pack.

9. The optical assembly as recited in claim 8, wherein the receiver includes a battery pack, wherein power for the display is provided by the receiver.

10. The optical assembly as recited in claim 8, wherein the power means is a battery.

11. The optical assembly as recited in claim 8, wherein the filter cap permits infrared light in the range of 900 to 1200 nanometers to pass through.

12. The optical assembly as recited in claim 8, wherein the display further comprising a rear housing having a recessed portion and a back surface, a quick mount ring positioned on the recessed portion of the rear housing, a flexible goose neck having a first end and a second end, wherein the second end is attached to the quick mount ring with a clamp and thumb screw, and the first end of the goose neck attached to a display mount, an inner cord relief having a center aperture and a plurality of screw apertures for attachment to an outer cord relief having a center aperture and a plurality of screw apertures, wherein the screw apertures of the inner and outer cord reliefs are in alignment, wherein the center apertures of the inner and outer cord reliefs are in nonalignment, said center apertures of the inner and outer cord reliefs for receipt of said connection means, wherein an outer surface of the outer cord relief defines the back surface of the rear housing of the display.

13. A method of using an optical assembly adjacent to the head of an operator, comprising:
providing a head gear worn by the operator, said head gear having a front side and a back side,
providing a display for viewing by the operator, said display having display circuitry mounted therein and mounted to the front side of the head gear,
providing a camera pack having image generating circuitry therein and further including a camera and a multi-channel transmitter,
providing a receiver having a multi-channel receiver board, said receiver attached to the back side of the head gear, wherein the transmitter of the camera pack is in wireless communication with the receiver,
providing connection means for interfacing the receiver to the display,
providing a white light flashlight having an illuminating end,
mounting a filter cap to the illuminating end of the flashlight,
positioning the display relative to the eye of the user, attaching the camera pack to the flashlight,
positioning the optical assembly so that the lens of the camera pack and the illuminating end of the flashlight are aligned along a single linear optical axis,
transmitting light from the flashlight through the filter cap,
reflecting said light from the filter cap generally in a first direction from said filter cap,
receiving said light reflected off an object and generating a video signal responsive to said received light, and
transmitting the video signal to an eye of the operator.
